(19) United States
(12) Patent Application Publication
(10) Pub. No.: US 2004/0093322 A1
(43) Pub. Date: May 13, 2004

(54) Method and system for information aggregation and filtering

(76) Inventors: Bertrand Peralta, La Haye Le Comte (FR); Christian Marest, Aubergenville (FR)

Correspondence Address: KENYON & KENYON, 1500 K STREET, N.W., SUITE 700, WASHINGTON, DC, 20005, US

(21) Appl. No.: 10/211,321

(22) Filed: Aug. 5, 2002

Related U.S. Application Data
(60) Provisional application No. 60/309,471, filed on Aug. 3, 2001.

(51) Int. Cl. G06F 17/30

(52) U.S. Cl. 707/3

(57) ABSTRACT

A filtering phrase is received as the basis for obtaining information of interest to a user. Linguistic analysis is performed on the filtering phrase to generate a plurality of categories. A categorization rule is applied to the categories to obtain search terms. The search terms are submitted to a search engine, which returns results especially pertinent to the filtering phrase.

### PRIORITY INFORMATION

This application claims the benefit of U.S. provisional application 60/309,471, Method and System For Information Aggregation and Filtering, filed on Aug. 3, 2001.

### FIELD OF THE INVENTION

The present invention relates to the field of information aggregation and filtering.

### BRIEF DESCRIPTION OF THE DRAWINGS

The invention will be more readily understood with reference to the following detailed description, with reference to the following drawings, in which:

FIG. 1 shows a system in accordance with an embodiment of the present invention.

FIG. 2 shows a filtering system in accordance with an embodiment of the present invention.

FIG. 3 shows a screen displaying aggregated and filtered information in accordance with an embodiment of the present invention.

FIG. 4 shows a system for building packages in accordance with an embodiment of the present invention.

FIG. 5 shows a list of channels in accordance with an embodiment of the present invention.

FIG. 6 shows a list of keywords in accordance with an embodiment of the present invention.

FIG. 7 shows a package in accordance with an embodiment of the present invention.

### DETAILED DESCRIPTION

The information aggregation and filtering service in accordance with an embodiment of the present invention provides a way for a user or group of users to receive a subset of information that has been gathered from diverse sites on network, where the subset of information is particularly relevant to the users' interests. Information is captured from sites on the network by the service and categorized into channels, which represent common themes or identifies a particular source of type of source of the information. The user can advantageously specify user preference/profile information that can be used to filter the channelized information to determine which of this information is particularly relevant to the user. Also, the user can advantageously provide textual and/or semantic filtering information to filter information. These features can be used alone or in combination to provide a particularly relevant set of information to a user, where the information has been gathered from an extensive universe of information available on sites on a network.

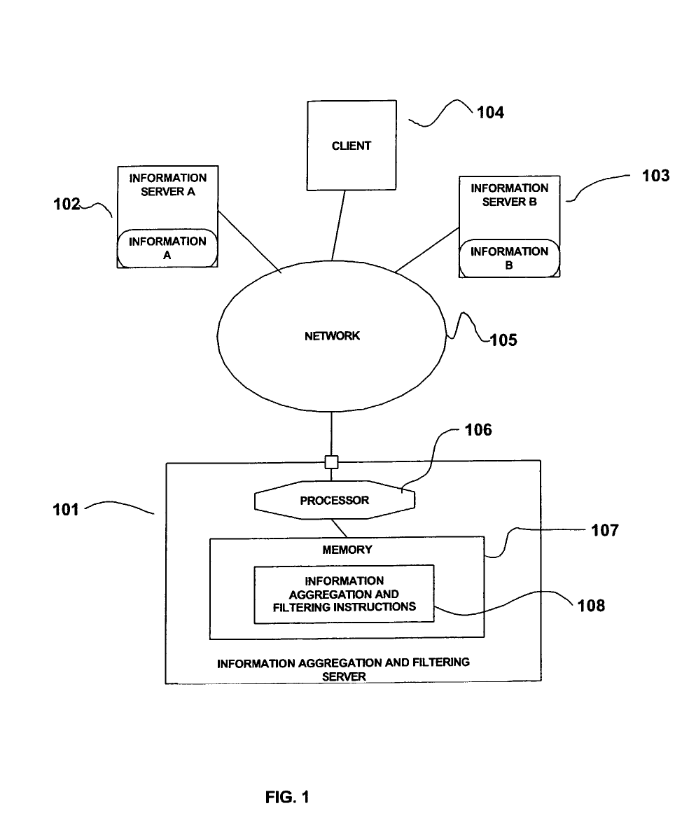

FIG. 1 shows a system in accordance with an embodiment of the present invention. An information aggregation server 101 is coupled to information server A 102 and information server B 103 and client 104 through network 105. Information server A 102 stores information A and information server B 103 stores information B. In accordance with an embodiment of the present invention, information aggregation server 101 fetches information from the information servers, organizes the fetched information into channels. Each channel represents an organization of information that has typically been fetched from a plurality of information servers along the lines of a single theme, or group of related themes. Thus, a channel typically represents an aggregation of information from sources coupled to the network (e.g., information servers 102 and 103) in accordance with one or more themes to which the information corresponds. A first set of information from a single source can be grouped with other information in a first channel, while a second set of information from the same source can be grouped with other information in a second channel. For example, an information server that includes information on aeronautics and metallurgy can contribute such information to an air transportation channel and a materials science channel, respectively. Likewise, a first piece of information from a single source (e.g., a single information server) can occur in more than channel. Thus, the aeronautic information in the previous example can occur in an air transportation channel and also in an aerospace technology channel. Likewise, information that occurs in a first channel can be aggregated in a second channel with other information not found in the first channel. For example, aeronautics and not metallurgy appears in the air transportation channel; metallurgy and not aeronautics appears in the materials science channel; and both the aeronautics and metallurgy information appear in the turbine design channel. A channel can also designate a particular source of information, such as an online version of a particular aerospace journal, such as Aerospace Weekly.

The information aggregation server 101 includes a processor 106 coupled to a memory 107. Processor 106 can be a general purpose microprocessor, such as the Pentium III microprocessor manufactured by the Intel Corporation of Santa Clara, Calif.; an Application Specific Integrated Circuit (ASIC) that embodies at least part of the method in accordance with an embodiment of the present invention in hardware and firmware; or a combination thereof. An example of an ASIC is a digital signal processor.

Memory 107 is any device adapted to store digital information, such as a Random Access Memory (RAM); Read Only Memory (ROM); a hard disk; an optical digital storage device such as a Compact Disk Read Only Memory (CD-ROM) or read/writeable compact disk; etc.

Memory 107 stores information aggregation and filtering instructions 108 adapted to be executed by processor 106 to perform the method in accordance with an embodiment of the present invention. For example, in one embodiment of the present invention, information aggregation and filtering instructions searches for information stored on various sites (e.g., information servers such as 102 and 103) that are coupled to network 105 (e.g., the Internet) in a systematic way, e.g., using a spider as is well known in the art, by conducting an update search every thirty minutes, etc. Information that is retrieved from sites coupled to network 105 are then organized (i.e., aggregated) into channels. For example a piece of information (such as a file, a web page, etc.) or a pointer to the piece of information (e.g., a Uniform Resource Locator, fully qualified file name, etc.) is stored in a database (not shown) correlated with a description (e.g., title) of the piece of information and the name of one or more channels. The database can be stored in memory 107 of the information aggregation and filtering server 101, or be stored remotely in a way that can be accessed by the information aggregation and filtering server 101. For example, the database can be coupled to the information aggregation and filtering server 101 locally, through a Local Area Network (LAN), through network 105, etc. An example of a record in the database is:

| LINK | TITLE | CHANNELS |
|---|---|---|
| http://www.acme.com/ | Airfoil | Aeronautics |
| aeronautics/airfoils.html | Designs | Air Transportation |
| | | Aerospace |

Network 105 can be a single network, or an internetwork comprised of a plurality of subnetworks. Network 105 can be the Internet, an intranet, an extranet, a Local Area Network (LAN), a Wide Area Network (WAN), an Ethernet, a wireless network, a connectionless or connection-oriented packet switched network, a circuit switched network, etc.

Information aggregation and filtering instructions 108 can include a “capture engine” for obtaining information stored on remote sites coupled to server 101 through network 105, and/or from a local storage medium such as a CD-ROM, hard disk, etc. The capture engine can also be implemented as a spider or other agent that automatically fetches content from sites coupled to network 105. The capture engine can advantageously analyse and fetch files in different formats such as Text, eXtensible Markup Language (XML), HyperText Markup Language (HTML), Wireless Markup Language (WML), etc. The information can be sent from a remote site to server 101 using any suitable protocol, such as HyperText Transport Protocol (HTTP), Wireless Access Protocol (WAP), File Transfer Protocol (FTP), etc. Server 101 uses the capture engine to fetch information and then classifies it by channel, and stores it (or a pointer to the information) in a content database. The database can be stored in memory 107. The capture of information can be a background process, which can be run once, more than once (e.g., it can be set to run on a regular basis), etc.

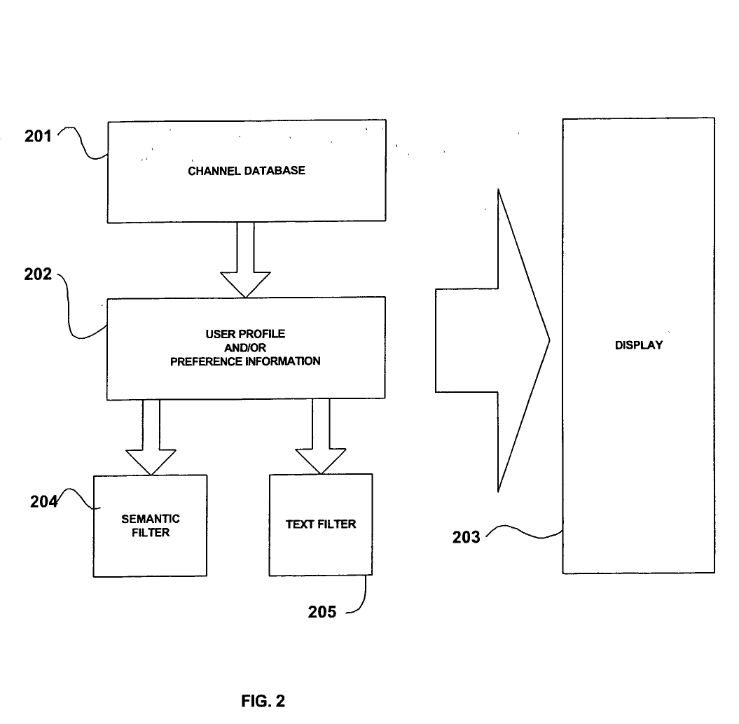

FIG. 2 shows a system that accommodates user preferences in accordance with an embodiment of the present invention. The functionality described in relation to FIG. 2 can be embodied in the information aggregation and filtering instructions 108 (FIG. 1) that are executed on processor 106. Information can be correlated with defined channels in one or more channel databases 201, e.g., a Lotus Notes database made by the IBM corporation and/or a Relational Database Management System (RDBMS), such as that made by the Oracle corporation. As described above, a record in a channel database 201 relates information that subsists locally to the information aggregation and filtering server I 01 (such as a locally-stored file) and/or remotely (e.g., on sites coupled to server I 01 through network 105), such as a web page, to one or more predefined channel description (e.g., air transportation, metallurgy, etc.) Each record in the database can also include information such as a description of the referenced information, the time at which the record was made, etc.

In one embodiment, the present invention includes user profile/preference information 202 used to filter material available (e.g., directly or by pointer) in the channel database. As used herein, user profile information includes information describing one or more characteristic of a user, e.g., demographic information about the user. User preference information includes information regarding the user's preferences in the selection and display of information by server 101. User profile and user preference information can be obtained from the user or from a third party in accordance with the invention.

User information 202 can be stored in a database either in memory 107, or in remote memory coupled to processor 106. User information 202 can advantageously be used to filter available channel information 201 to present a customized view of information that is particularly relevant to a user or group of users. For example, a user can specify its preferences using a form-based graphical user interface, as is known in the art. Thus, a user can specify its preference to see information related to aeronautics and aerospace. In response, an embodiment of the present invention filters (selects) and displays 203 only that channelized information related to aeronautics and aerospace to presentation to the user on client computer 104. User profile information can also be specified for a user or group of users by a third party. For example, the management of a company can specify that the company's stock price be shown to all users that are employees of the company when the users access the information aggregation and filtering service in accordance with an embodiment of the present invention.

The system shown in FIG. 2 can be used for a portal that corresponds to a particular theme, such as aeronautics. Information to be presented by the system at the portal can be drawn from channels that contain information relating to the theme. These channels can relate to specialized information (e.g., Aerospace Weekly magazine) or general information (e.g., the BBC Online web site.) The information included in a channel can be in any language. In one embodiment of the present invention, these channels can be selected from over 30 000 available channels. Specialized channels can be presented in their entirety. Channels with general information should be filtered with keywords in order to keep the displayed elements of information from those channels consistent with the theme of the portal. The enforcement of this thematic discipline on a portal can be performed using the profile 202 discussed above. In this way, a specialized portal will contain only information relevant to its theme.

An embodiment of the present invention advantageously provides the capability for a user to further customize the information that the user is shown by providing textual 204 or semantic 205 keywords to information aggregation and filtering server I 01. A particular combination of channel information and/or user profile information and/or text and/or semantic keywords generates a configuration of information called an information package, or simply “package.” These criteria used to characterize the contents of the package are called “package parameters.” The contents of a package can be general to all users, customized to a particular group or groups of users, or even customized to a single user that is provided a unique view of information captured from sites on network 105.

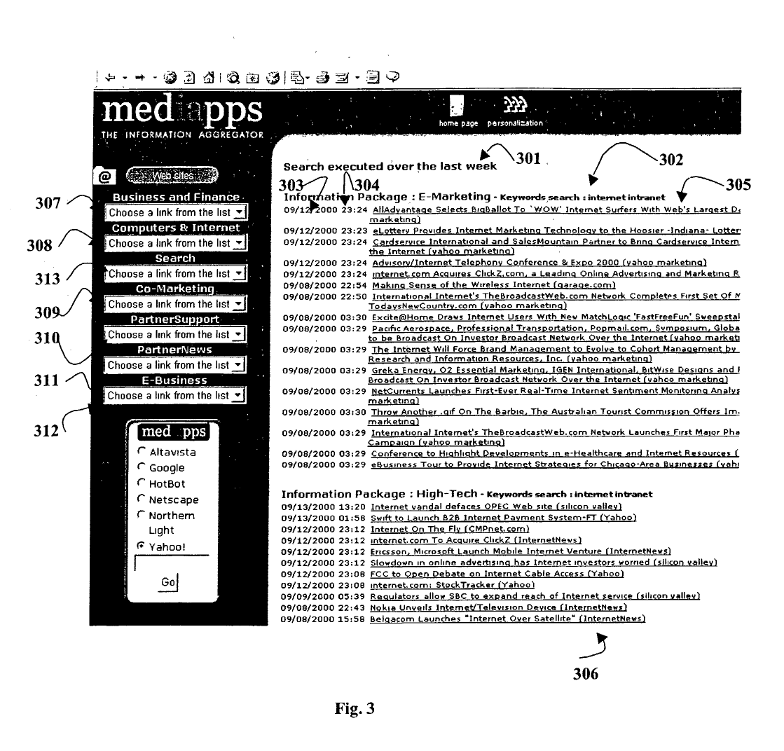

An embodiment of the present invention includes a “package tool” for assembling a thematically related set of information for presentation to a user. For example, an aeronautic package can be defined by using a profile comprised of some or all of the information collection tools disclosed herein. The aeronautic package can, for example, be formulated by selecting a set of aeronautic channels without filtering, and some general information channels with keyword filtering. FIG. 3 shows a screen displaying filtered information (packages) in accordance with an embodiment of the present invention. The semantic techniques for obtaining these results is set forth below.

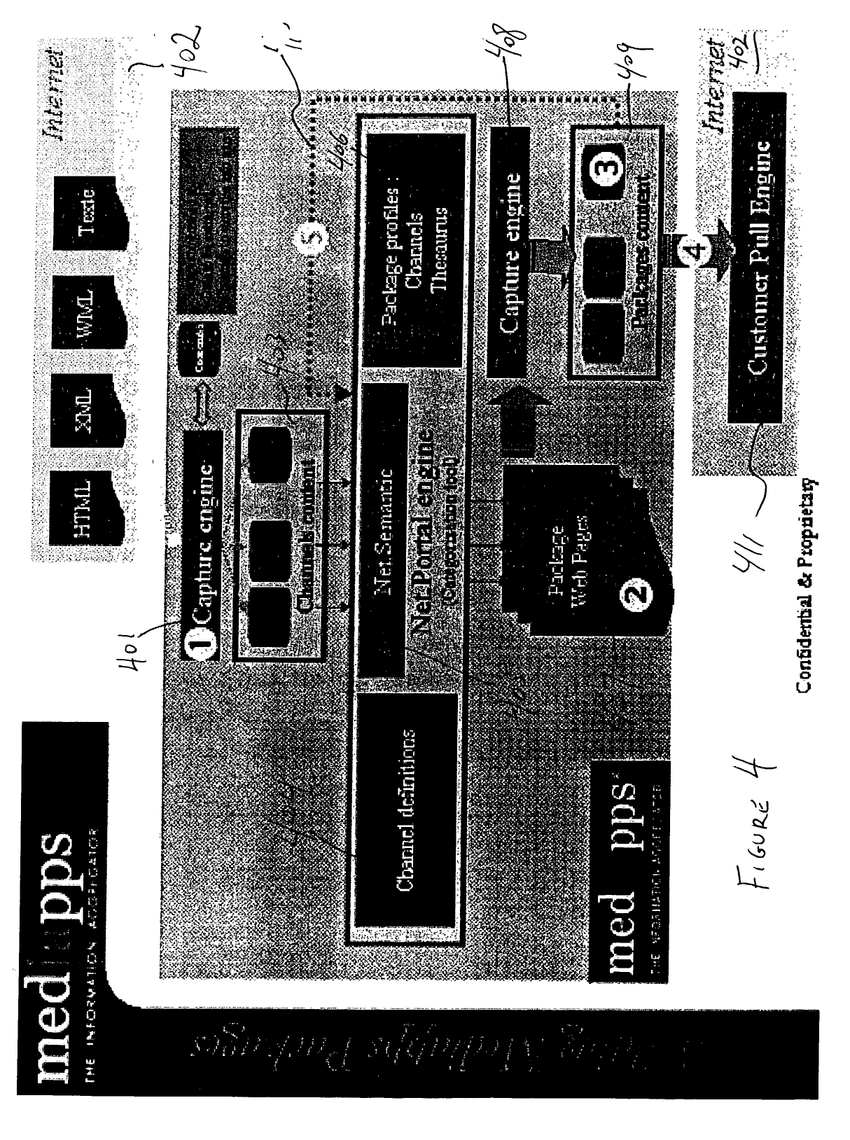

As shown in FIG. 4, a NetPortal Capture Engine 401 can periodically connect to the Internet 402 to capture information from sources such as Hypertext Markup Language (HTML) pages, eXtensible Markup Language (XML) pages, and any other type of information that is available in any other format over the Internet 402. A package can be made of several complete channels, several filtered channels, or a combination thereof. The filter can be comprised of keywords, semantic concepts such as those described herein, or a combination thereof. The information gathered for a package can be stored at a server, e.g., the server that runs the NetPortal Capture Engine 401. Another instance of the NetPortal Capture Engine 401 can send a request for the package content to the server. In response, the server provides the package information to the requester. In one embodiment, a first NetPortal Capture Engine runs on a first computer that assembles the package, and a second NetPortal Capture Engine runs of a second computer. The second NetPortal Capture Engine requests package information (e.g., a particular package) from the first NetPortal Capture Engine, which sends the requested package information to the requester. In another embodiment, two instances of the NetPortal Capture Engine operate on the same machine, and package information is exchanged between the two instances. A package can advantageously serve as input (i.e., as components) to other packages, to channels, etc.

FIG. 4 shows other elements of an embodiment of an information aggregator in accordance with the present invention. Channel content 403 can be sent for processing using channel definitions 404 and semantic filtering 405. These and package profiles, channels and keyword lists (e.g., thesaurus) 406 can be used to dynamically generate web pages 407. These web pages can in turn be used as input to another capture engine 408 to compose packages content 409, again using the channel definitions 404, semantic filter 405 and package profiles, channels and thesaurus 406 described above. This is signified by dotted line 410. Ultimately, the results are provided to a user, e.g., having a customer pull engine 411.

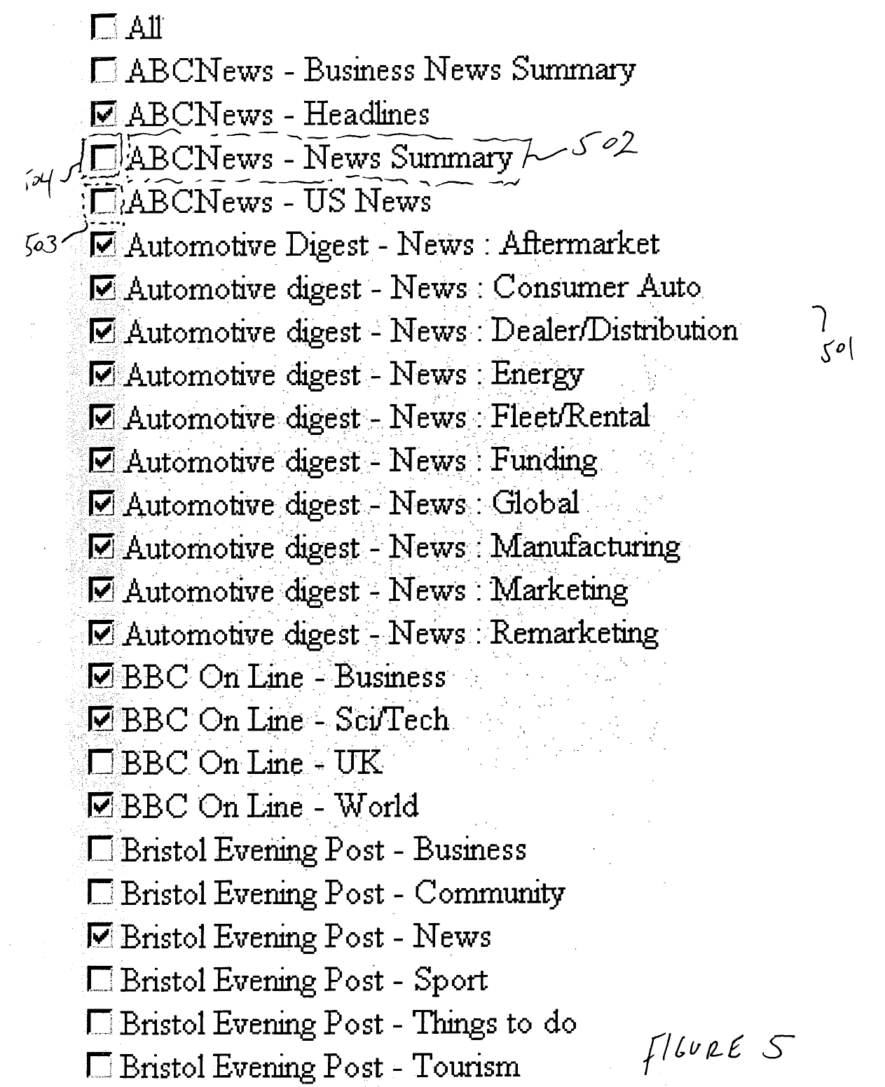

An example of part of the mechanism used to form a package is shown in FIG. 5, which shows a channel selection screen 501. The screen includes channel identifiers, such as 502. Each channel identifier has a checkbox, such as 503. A user selects channels by checking the box 504 next to the appropriate channel identifier 502 to indicate that the selected channel should serve as a source of material for the package.

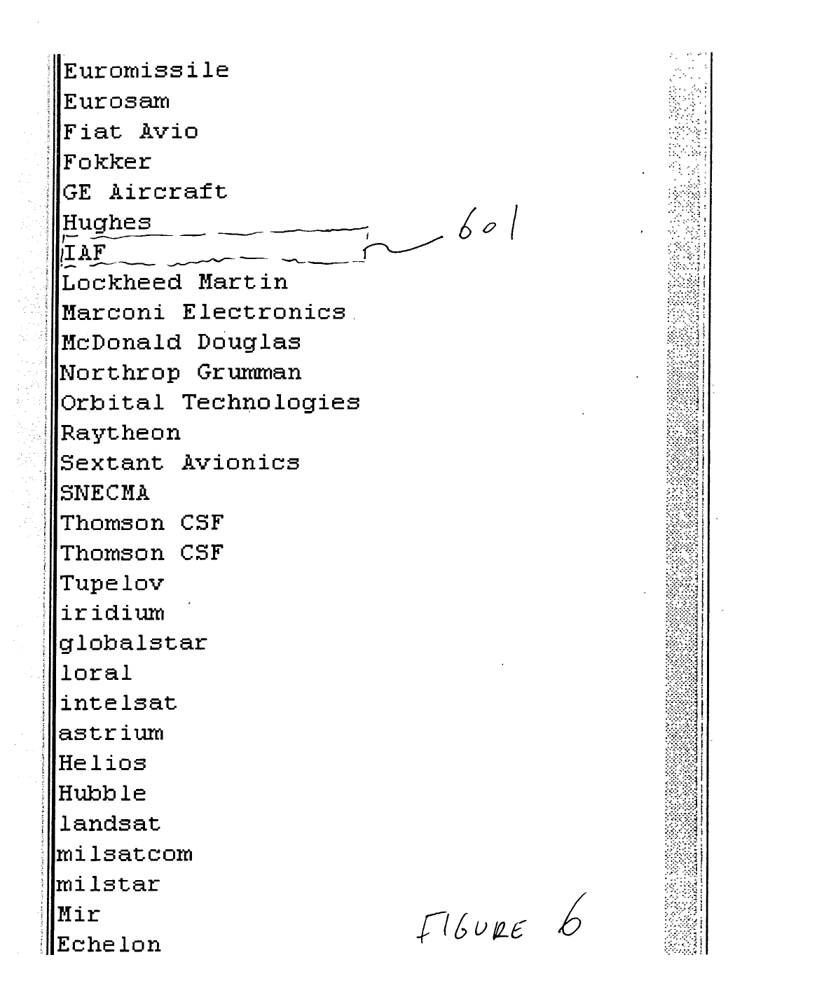

Next, the user can specify keywords to be used to filter the content of the selected channels. A list of such keywords for an exemplary aeronautic package is shown in FIG. 6. These keywords limit the information fetched from these channels, to, for example, articles containing certain trademarks and trade names belonging to aeronautical companies. A user can select a keyword such as “IAF” 601 and highlight it. The user can select more than one such keyword from the list, and/or specify certain other keywords himself (not shown).

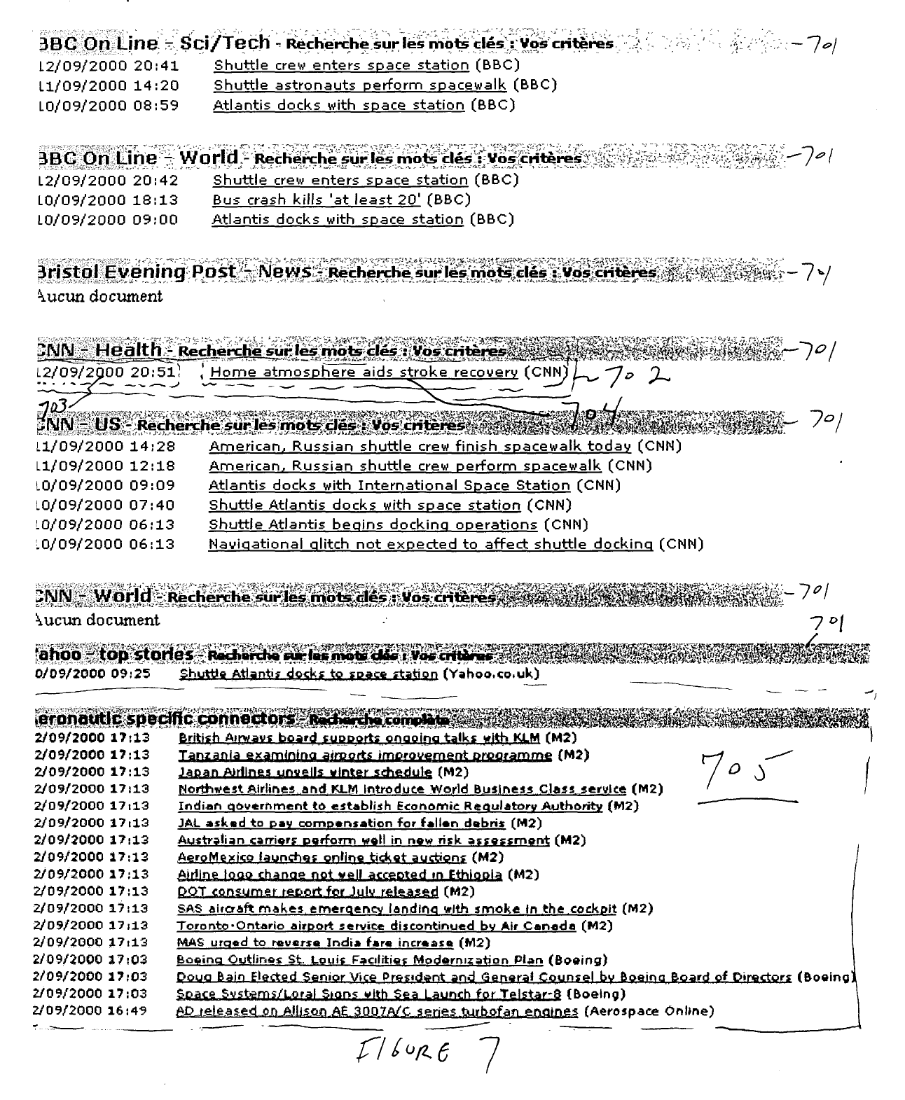

The result can be displayed to the user as shown in FIG. 7. FIG. 7 shows an aeronautical package formatted with channel identifiers 701, and document information for items within each channel. An example of document information is “Home atmosphere aids stroke recovery” 702. The document information includes the date and time of publication 703, and the title 704 of the document. The title 704 of the document is a hyperlink to that document. When the user selects a title, the document can be displayed to the user, e.g., by opening another window of the user's browser and displaying the document in the new window. The package also includes the results of keyword and/or semantic filtering for aeronautics under the heading, “Aeronautic specific connectors” 705.

Thus, a new package can be made in accordance with an embodiment of the present inventions by using the contents of a thematic portal (e.g., another package) as a source of information (e.g., a channel) for the new package. For example, a package relating to jet engines and a package relating to airfoils can both be used as inputs to form a package relating to the theme of powered flight. In this situation, the information aggregation system (NetPortal) is not used as an interactive tool for a human user, but as a tool for the manufacture of packages used by another instance of NetPortal. Thus, a package can be used for either or both of a traditional user-friendly portal, or as an input to the formation of another package.

For example, consider the aeronautic package. Initial sources of information for this package can include specialized sources such as the Boeing web site, the site Aeronotic Online, and general sources such as Yahoo and CNN as filtered by the appropriate key words and/or semantic concepts that pertain to the theme <<aeronautics.>> Information is aggregated from these sources to obtain a page of information that includes current events in the world of aeronautics. This page of information can be used as a portal, and/or as a source of information in the form of a channel of information. This advantageously makes the page useful as is, or to be further filtered. FIG. 3 shows two packages that are aggregated, HighTech 306 and Marketing 302. Likewise, the aeronautic package can be used as a part of another package, such as a transportation package. Alternatively, it could be used as a source of information that is further filtered to generate an aviation package that contains some, but not all, of the information contained in the aeronautics package.

FIG. 3 shows a screen displaying filtered information (packages) in accordance with an embodiment of the present invention. The page advantageously shows when the search of sites on network 105 was last performed 301 in accordance with package parameters. The first package is an “e-marketing” package 302, generated using channel information, user preferences and a text search designed to capture information on network 105 pertaining to electronic marketing, and to show the results that are most pertinent to the user's interests. Each displayed link to information in the package includes the date 303 and time 304 on which the information was generated and/or posted, and descriptive material 305 about the information. A second package on high technology 306 is also shown. Links to various predefined packages are provided in the general categories of business and finance 307; computers and the Internet 308; and co-marketing 309. Links are also advantageously provided to a search capability 313; partner support pages 3 10; partner news 31 1; and e-business 312.

The techniques that can be employed in an embodiment of the present invention to select the most relevant information to provide to a user include keyword and semantic filtering. In keyword filtering, a user can advantageously provide text search/filtering terms to the information aggregation and filtering server, e.g., by entering the keyword “turbines” on a thematic portal relating to aeronautics. Such a text filtering term would help to limit the information displayed to the user to information pertaining to aerospace turbines. The text provided by the user can be a Boolean expression in accordance with an embodiment of the present invention. For example, “(turbines AND bypass) OR turbofan AND NOT titanium.” Such a phrase would limit the information provided to the user to aerospace information relating to high-bypass turbines or turbofans, and exclude information pertaining to the use of titanium in such turbines or turbofans. In this way, an embodiment of the present invention can advantageously precisely filter information in accordance with the user's requirements.

In accordance with an embodiment of the present invention, the user can also employ semantic filtering. Certain conventional search technology constructs an index based upon words contained in a set of searchable information. The construction of this index is based upon a linguistic analysis of the underlying information, followed by the categorization of the results of the analysis, typically using predefined categories in accordance with predefined rules. The resulting index base can then be searched using a search engine. This approach suffers from many disadvantages. First, the predefined categories and categorization rules are typically predetermined. Thus, when a piece of information does not fit well into one of the predetermined categories, it is misclassified, or else omitted from categorization. General categorization rules are never perfect, and can misclassify information, or lack the capacity to classify certain information at all. Thus, for this known system to be effective, categories and categorization rules must be continually updated, which is labor intensive and expensive. Further, an index that is constructed in accordance with a certain methodology is typically more amenable to providing relevant results with a particular type of search engine. Other types of search engines can be less effective at providing good results from the index.

In accordance with an embodiment of the present invention, semantic filtering advantageously does not require linguistic analysis and particular categorization rules for the underlying information, i.e., the information that is to be filtered. Rather, linguistic analysis is applied to the query itself (such as words and phrases provided by the user.) Examples of such linguistic analysis include associating word endings ; recognizing the syntactical function query terms play within a query phrase; and using a library of terms that are useful for filtering that have been obtained by conventional linguistic analysis. The results of the linguistic analysis applied to a filtering phrase are used to categorize the phrase. Natural language analysis techniques that are known in the art can be used to analyze and categorize a filtering term or phrase in accordance with an embodiment of the present invention. As used herein, the term <<filtering phrase>> means one or more words or fragments (e.g., using wild cards). Examples of filtering phrases includes <<aerospace,>> <<aerospace AND turbines,>> <<(aerospace AND turbines) OR turbofan,>> aero ! OR turbofan*,>> etc. The character ! in the previous example is a wildcard for any number of characters. Thus, aero! includes <<aerospace,>> <<aeronautics,>> etc. The character * is a wildcard for a single character. Thus, turbofan* includes <<turbofan>> and <<turbofans.>> This generates a list of one or more categories of information to which the filtering phrase applies. Because an embodiment of the present invention analyzes the filtering phrase rather than just the searchable information, it advantageously operates well with almost any type of search engine.

Next, the semantic searching proposes applies categorization rules to the categories obtained as a result of the linguistic analysis. For example, a categorization rule may dictate that all derived categories that begin with the phrase <<aero >>be consolidated into a single category called <<aerospace.>> This can advantageously reduce the number of categories. Likewise, should circumstances dictate, the number of categories can be advantageously expanded. For example, a categorization rule can dictate that any piece of information associated with the category <<aerospace >>also be associated with the categories <<air transportation>> and <<aeronautics.>> Thus, categorization rules can advantageously be adapted to suit the needs of a particular aggregation and filtering architecture in accordance with an embodiment of the present invention.

The result of applying the categorization rules can be a set of terms. This set of terms, which are based upon the categorization of the filtering phrase, is applied by a search engine (e.g., a conventional, known search engine or a customized search engine) to an index of the searchable information. The result of this step is a filtered set of information responsive to the semantic filtering phrase.

The filtered information can advantageously by further processed in accordance with an embodiment of the present invention to determine the relative relevance of each piece of information in the filtered set (e.g., ranked according to relevance), and/or to classify each piece of information. For example, the filtered documents can be analyzed linguistically, etc. The filtered documents can then be categorized, and the categories can be altered, reduced or expanded in accordance with predetermined categorization rules. Note that this linguistic analysis and categorization rules, which are applied to the filtered information, need not be the same as the linguistic analysis and categorization rules applied to the filtering phrase. The resulting categorization can advantageously be used to present the documents in a useful fashion to the user, or as a basis for further filtering (e.g., utilizing user preference/profile information).

The use of semantic filtering in accordance with an embodiment of the present invention to analyze the filtering phrase rather than the searchable information is advantageously efficient. The searchable information need not be extensively analyzed to generate an index that is specially derived for an embodiment of the present invention. Rather, an embodiment of the present invention can use any index of searchable information. Thus, processing steps involving the searchable information are fast. Such processing can also be independent of any particular categories and categorization rules that may exist at any given time. Again, because the filtering query is analyzed using categories and categorization rules, these categories and categorization rules can be updated without having to reexamine and reprocess the entire set of searchable information. This emphasis on analyzing the filtering phrase means that practically any known search engine can be used to examine the searchable information, using the results of the filtering phrase analysis in accordance with an embodiment of the present invention. The accuracy and relevance of the result of this filtering can be more accurate than known aggregation and filtering systems.

In accordance with an embodiment of the present invention, the categories used to analyse the filtering phrase are constructed linguistically. The category is the basic element of a dictionary. A category is constituted by three tropic classes, and forms a directed segment allowing a connection. A Tropic class also known as Trope is a figure of speech, especially one that uses words in senses beyond their literal meanings. The theory of rhetoric has involved several disputed attempts to clarify the distinction between tropes (or ‘figures of thought’) and schemes (or ‘figures of speech’). The most generally agreed distinction in modern theory is that tropes change the meanings of words, by a ‘turn’ of sense, whereas schemes merely rearrange their normal order. The major figures that are agreed upon as being tropes are metaphor, simile, metonymy, synecdoche, irony, personification, and hyperbole; litotes and periphrasis are also sometimes called tropes.

The first tropic class (TC1) consists of the sememe (basic semantic character). A <<sememe>> is the meaning of a <<morpheme,>> which is a meaningful linguistic unit that contains no smaller meaningful parts. A morpheme may exist in a free state, as in the word “box,” or it may be bound to another unit, as the “es” of “boxes.” The second tropic class (TC2) consists of semantic traits corresponding to the ideas invoked by the sememes. The third tropic class (TC3) consists of semantic traits corresponding to the concepts,in the ideas of the second tropic class. The segment, directed in the order TC1, TC2, TC3 points to a categorization rule, also known as a <<connector>> and designated <<F1.>>

For example, the word “book” in its first sense, that of “a work” can be associated with the following categories: TC1: work; TC2: artisanal or industrial production; TC3: communication, language; and F1: society (or collective).

The sememes of the first tropic class are taken from a corpus of a limited number of predefined sememes. The sememes of the corpus have the following features: the sememes are non-contradictory, i.e. are perceived in the same way by a speaker of a Western Indo-European language; and the sememes are unique, when associated with TC2s and TC3s. In one implementation of the present invention, 873 sememes are used, and are obtained as described herein.

The second tropic class is comprised of semantic traits corresponding to ideas evoked by the sememes. In one embodiment of the present invention, about 100 traits are used.

The third tropic class is comprised of semantic traits corresponding to concepts from the ideas of the second tropic class. In one implementation of the present invention, 25 classes are used.

The connector enables the connection rules discussed above to be established. The connector can adopt three values or classes: anthropological (concerning a person alone as a human being); for example, vision or pain come in the anthropological class; social (or collective, concerning an association of humans, or a person in a relation); for example, the book, theater or love fall within the collective class; and fundamental, defined by exclusion as being neither man nor collective. For example, <<light>> and <<God>> fall within the fundamental class.

In one embodiment of the present invention, the categories and tropic classes are in a finished state. These are obtained using a general optimization process that eliminates redundant information from sources consisting of the French Quillet, Littre and Robert dictionaries. These sources were chosen as they are representative of different dictionary drafting periods. The dictionaries are first processed to obtain a set of definitions using known scanning, optical character recognition (OCR) and linguistic techniques. Once the definitions have been obtained, a statistical analysis technique is applied to the linguistic interval in the definitions. A Linguistic Interval is the minimum of signification between two words.

The result is a set of semantic traits, with an value for the amplitude of variation in the meaning of the terms.

Next, the classification process using the three classes defined above is applied to the semantic traits obtained. The semantic traits are then separated in order to isolate the ideas and concepts from the remainder (the sememes). This produces the list of TC1s, TC2s and TC3s. These lists are processed for detecting and eliminating redundant entries. For example, a single term in each category is chosen (e.g., arbitrarily), and all redundant terms are then eliminated. This produces lists of unique terms, for the sememes, ideas and concepts, which are each matched to a class.

Next, using a linguistic interval comparator, a concept and an idea can be associated with each sememe to form a triplet (TC1, TC2, TC3.) Next, the connections are assigned manually. The result is a finite number of sememes, each associated uniquely with a concept, an idea and a connector. One can note here that it is advantageous to choose an order for the categories, following symbiotic sequencing rules defined by Marty. The use, by analogy, of the symbiotic square makes it possible to apply a contextual order between terms, and to precondition connections between categories.

Next, one or more categories are assigned to each term of the language by detecting the minimal distance (the linguistic interval) between a term and the categories. The choice of minimal distance at this stage makes it possible to play on the number of categories that can be assigned to each term of the language. The result obtained is characterised by its stability. This stability is an index—or more exactly a consequence—of the validity of the categories proposed and a suitable choice of the minimum distance when assigning categories to the terms of the language.

An embodiment of the present invention advantageously does not depend upon categories that are recreated in a given context and which are necessarily limited and have to be regularly updated. The linguistic modelling in accordance with an embodiment of the present invention can be advantageously complete from the outset. It need not be updated, and can be universal because it is not only pertinent to any one sector of human activity, but to all such sectors. This complete and universal characteristic of an embodiment of the present invention is due to stability of the categories. This is a consequence of the new and useful way in which these categories are derived in accordance with the present invention. The categories can also be advantageously independent of any particular language. They can be transcribed from one language to another. The initial choice of a language having a high abstract content can allow the transfer of categories to other languages without substantial loss of meaning.

The linguistic analysis, filtering and aggregation system and method in accordance with the present invention provides a more precise and universal way to extract relevant information according to various criteria from a universe of information.

What is claimed is:

1. A method comprising:
receiving a filtering phrase;
generating a plurality of categories based upon a linguistic analysis of the filtering phrase;
applying a categorization rule to obtain at least one search term based upon the categories; and
submitting the search terms to a search engine.
